(19) United States
(12) Patent Application Publication
(10) Pub. No.: US 2011/0279265 A1
(43) Pub. Date: Nov. 17, 2011

(54) SYSTEM FOR DISPLAYING INFORMATION RELATED TO AN OPERATIONAL PARAMETER OF A BIOLOGICAL SAFETY CABINET

(75) Inventors: Robert Kenneth Haugen, Statesville, NC (US); Karole D. Clanton, Stony Point, NC (US)

(73) Assignee: Kewaunee Scientific Corporation, Statesville, NC (US)

(21) Appl. No.: 12/777,817

(22) Filed: May 11, 2010

(51) Int. Cl. G08B 21/00

(52) U.S. Cl. 340/540

(57) ABSTRACT

A system for displaying information related to an operational parameter of a biological safety cabinet that may change during ongoing operation thereof, comprises a sensor for detecting a prevailing value of the operational parameter at least periodically during operation, a display comprising a pictorial graphic having a series of adjacent arcuate segments graphically representing a range of possible values for the operational parameter between a minimum value represented by a first segment, a maximum value represented by a last segment, and incremental intermediate values represented by a plurality of segments intervening between the first and last segments, and a processor associated with the sensor and with the display for comparing the prevailing value of the operational parameter to the range of possible values and selectively actuate illumination of all, none or another number of the segments to visually signify the prevailing value in relation to the range of values.

### BACKGROUND OF THE INVENTION

The present invention relates generally to biological safety cabinets and, more particularly, to means and methods for providing users with information related to operational parameters of such biological safety cabinets which may change during ongoing operation.

Biological safety cabinets provide a biohazard containment means which enable laboratory personnel in diverse industries, e.g., life science, medical, and pharmaceutical industries, to perform various laboratory, experimental and like procedures utilizing biologically hazardous substances while protecting the personnel, the work product and the ambient environment from exposure to and contamination by such substances. Biological safety cabinets are currently certified by the National Sanitation Foundation (NSF) International, of Ann Arbor, Mich., according to three levels of classification. The present invention is described herein in an embodiment adapted to a biological safety cabinet of the type referred to as a Class II cabinet, particularly sub-type A2, but the present invention has broader applicability to all classes and types of biological safety cabinets.

Class II A2 biological safety cabinets basically have a work chamber that is mostly enclosed except for a front access opening sufficient for a user's hands to perform procedures within the work chamber. An air circulation system maintains a continuously circulating positive air flow within the work chamber which is controlled to move laminarly in parallel relation to the front access opening to prevent escape of the internal cabinet air outwardly through the forward access opening to protect the user and the ambient area from contamination. The air circulation system utilizes a fan to continuously withdraw air from the work chamber into an adjacent filtration chamber from which a portion of the air is recirculated into the work chamber through a first high efficiency particulate air filter, commonly referred to as a HEPA filter, while the balance of the withdrawn air is exhausted outside the cabinet through a second HEPA filter. Typically, a ratio of about 70% recirculated air to 30% exhausted air is maintained in Class II A2 cabinets. The exhausted air is replaced by ambient air from the surrounding room drawn first into the filtration chamber before entering the work chamber through the first filter, thereby to prevent room air contamination of the work chamber and also to maintain the integrity of the laminar air flow along the front access opening.

It is important that the filters in such biological safety cabinets be replaced with sufficient frequency to maintain uniformity in the laminar velocity of the circulating air and to minimize airborne contaminants in the circulating air. In turn, therefore, it is important that personnel monitor the degree of loading of the filters with contaminants to be alerted to replace the filters when reaching or approaching a predetermined full condition. It is correspondingly important that personnel continuously monitor the so-called face velocity prevailing within the cabinet, i.e., the velocity of the laminar air flow at the front access opening into the work chamber.

Various means and devices are available to measure these operational parameters, and other operational parameters of biological safety cabinets. Not only is it important that the sensor and measurement means be reliable and accurate, it is equally important that the relevant information be presented to operating personnel in a clear, organized, intuitive and readily understood format enabling users to quickly assess the status of these operational parameters without diverting attention away from the procedure being performed within the cabinet for any extended period of time. Known conventional biological safety cabinets typically utilize gauges, LED displays and/or monochrome liquid crystal displays that may require a detailed or high level of knowledge of the operation and functioning of the cabinets and are not immediately intuitive to interpret.

Hence, there is a need in the industry for a form of informational display in biological safety cabinets for presenting operational information to operating personnel in a simple, easily understood and intuitive manner.

### SUMMARY OF THE INVENTION

The present invention seeks to address the foregoing needs of the industry, and to overcome the deficiencies of the state of the art, by providing an improved graphical system for displaying information related to one or more operational parameters of a biological safety cabinet that may change during ongoing operation thereof. Basically, the display system comprises a sensor for detecting a prevailing value of a selected operational parameter at least periodically during operation, a display adapted to present a pictorial graphic representative of the prevailing value of the parameter, and a processor associated with the sensor and with the display for controlling the actuation of the display. According to the present invention, the pictorial graphic of the display includes a series of adjacent arcuate segments graphically representing a range of possible values for the operational parameter between a minimum value represented by a first segment, a maximum value represented by a last segment, and incremental intermediate values represented by a plurality of segments intervening between the first and last segments. The processor is operative to compare the prevailing value of the operational parameter to the range of possible values and selectively actuate illumination of all, none or another number of the segments to visually signify the prevailing value in relation to the range of values.

The graphical display system of the present invention is susceptible of many and various desirable embodiments. For example, the present display system may be utilized to provide a graphical display representing essentially any operational parameter which may warrant periodic monitoring during ongoing operation of the biological safety cabinet, but typically operational parameters that may be expected to change during ongoing operation of the cabinet and/or parameters whose value provides an indicator of the satisfactory or unsatisfactory operation of the cabinet. One parameter that will typically merit monitoring and display is the degree of contamination loading of an air filter in the biological safety cabinet, which may advantageously be expressed as a percentage of the remaining filter capacity of the filter. Another parameter which is desirable to monitor is the velocity of air flow entering the containment area of the biological safety cabinet.

The pictorial graphic may be provided with particular features, characteristics and/or capabilities to enhance the recognition and understandability of the display, e.g., the segments of the display may be adapted to illuminate in different colors, such as wherein at least the first segment illuminates in a first color, at least the last segment illuminates in a second color, and at least one of the intermediate segments illuminates in a third color. The graphical display may also include a numerical graphic, with the processor being further operative to cause the numerical graphic to display a numeral corresponding to the prevailing value of the operational parameter. The display may further comprise an audio-visual screen for displaying video content stored in a memory of the processor. The display may also comprise other selectively actuable alert signals.

In one particularly preferred embodiment, the graphical display system comprises a first sensor for at least periodically detecting a prevailing value of a degree of contamination loading of an air filter in the biological safety cabinet, and a second sensor for at least periodically detecting a prevailing value of air flow velocity circulating within the biological safety cabinet. A first display comprises a first pictorial graphic having a first series of adjacent arcuate segments graphically representing a range of possible values for the contamination loading of the air filter between a minimum value represented by a first segment, a maximum value represented by a last segment, and incremental intermediate values represented by a plurality of intermediate segments between the first and last segments, and further comprising a first numerical graphic associated with the series of arcuate segments. A second display similarly comprises a second pictorial graphic having a second series of adjacent arcuate segments graphically representing a range of possible values for the air flow velocity between a minimum value represented by a first segment, a maximum value represented by a last segment, and incremental intermediate values represented by a plurality of intermediate segments between the first and last segments, and further comprising a second numerical graphic associated with the series of arcuate segments.

In this embodiment, a processor is associated with each of the first and second sensors and with each of the first and second displays. The processor is operative for calculating a percentage of the remaining filter capacity of the filter based upon the prevailing value of the degree of contamination loading of the air filter and selectively illuminating all, none or another number of the segments of the first pictorial graphic to visually signify the remaining filter capacity of the filter. The processor also causes the first numerical graphic to display a numeral corresponding to the percentage of the remaining filter capacity of the filter. The processor is further operative for calcaulating the prevailing value of the air flow velocity circulating within the biological safety cabinet and selectively illuminating all, none or another number of the segments of the second pictorial graphic to visually signify the prevailing value of the air flow velocity. The processor also causes the second numerical graphic to display a numeral corresponding to the prevailing value of the air flow velocity.

### BRIEF DESCRIPTION OF THE DRAWINGS

FIG. 1 is a partially exploded and partially broken-away perspective view of a biological safety cabinet in which the present graphical display system of the present invention may preferably be embodied;

FIG. 2 is a vertical cross-sectional view of the biological safety cabinet of FIG. 1, taken along line 2-2 thereof;

FIG. 3 is another vertical cross-sectional view of the biological safety cabinet of FIG. 1, taken along line 3-3 thereof;

FIG. 4 is a schematic diagram depicting the display system of the biological safety cabinet; and

FIG. 5 is an elevational view of the graphical display panel of the display system.

### DETAILED DESCRIPTION OF THE PREFERRED EMBODIMENTS

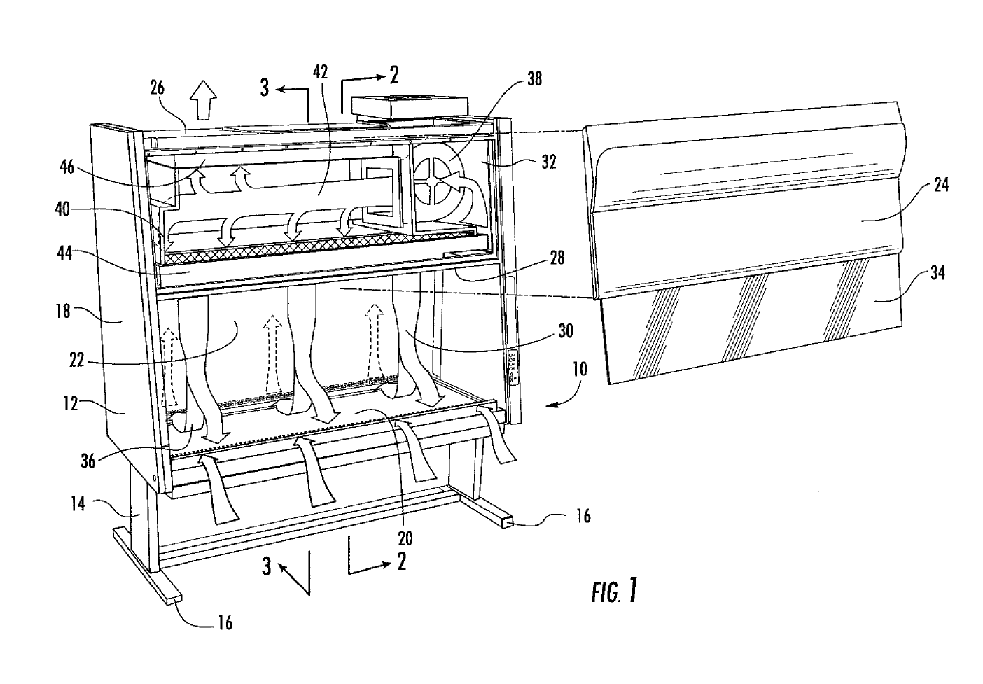

Referring now to the accompanying drawings, and initially to FIG. 1, a representative form of biological safety cabinet in which a graphical display system according to the present invention may preferably be embodied is indicated generally at 10. The safety cabinet 10 basically comprises a housing 12 supported on a trestle stand 14, which may include a set of casters 16 for moveability of the cabinet structure. The housing 12 is a generally rectangular structure having spaced-apart end walls 18, a bottom wall 20, a rear wall 22, a partial front wall 24, and a top wall 26, collectively defining an open interior which is divided by a horizontal intermediate wall 28 into a lower work chamber 30 and an upper air recirculation chamber 32. The housing 12 may preferably be fabricated of sheet metal, such as stainless steel.

The partial front wall 24 predominately encloses only the air recirculation chamber 32, leaving open front access by users into the work chamber 30. A transparent sash 34 is supported by and extends downwardly from the front wall 24 to partially enclose the work chamber 30 except for a narrow front access opening 36 into the work chamber 30 between the bottom wall 20 and the lower edge of the sash 34 through which users may have manual access into the work chamber 30. The transparency of the sash 34 permits visual access into the work chamber 30 by users. The sash 34 may also be retractable as necessary to permit greater access into the work chamber 30 by users.

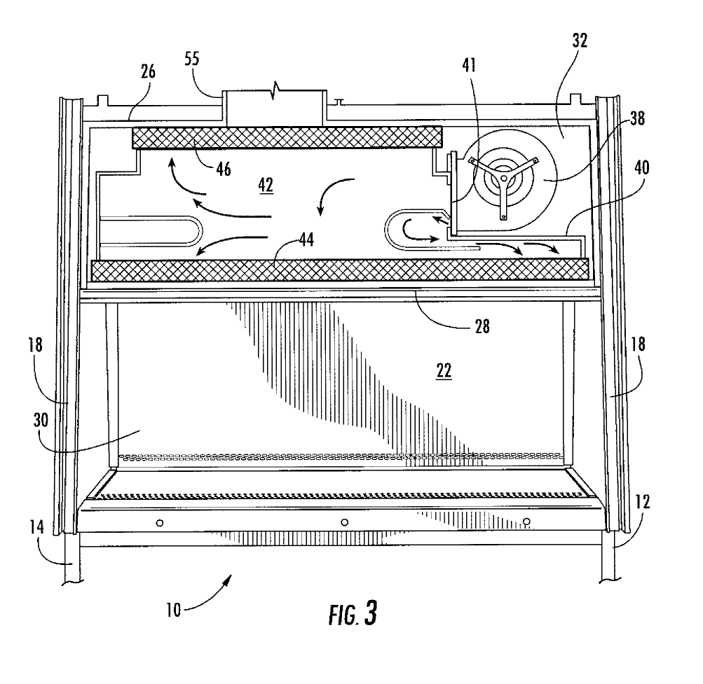

In FIG. 1, the front wall 24 is shown in exploded relation to the remainder of the cabinet 10 for illustration of the air recirculation chamber 32. As shown in FIG. 1 and further seen in FIG. 3, the majority of the air recirculation chamber 32 is occupied by a hollow sub-housing 40 the open interior of which serves as an air filtration chamber 42. An air circulation fan 38 is mounted within one end of the recirculation chamber 32 with the output side of the fan 38 mounted to one end of the sub-housing 40 to discharge blown air under positive pressurize into the air filtration chamber 42. The lowermost bottom side of the sub-housing 40 is open with a first air filter 44 affixed to the sub-housing in covering relation to the opening. Similarly, the uppermost topside of the sub-housing 40 is open with a second air filter 46 affixed to the sub-housing in covering relation to the opening. The two air filters 44, 46 are preferably high efficiency particulate air filters, more commonly referred to as HEPA filters, for their ability to capture molecular-sized microorganisms and like biological matter.

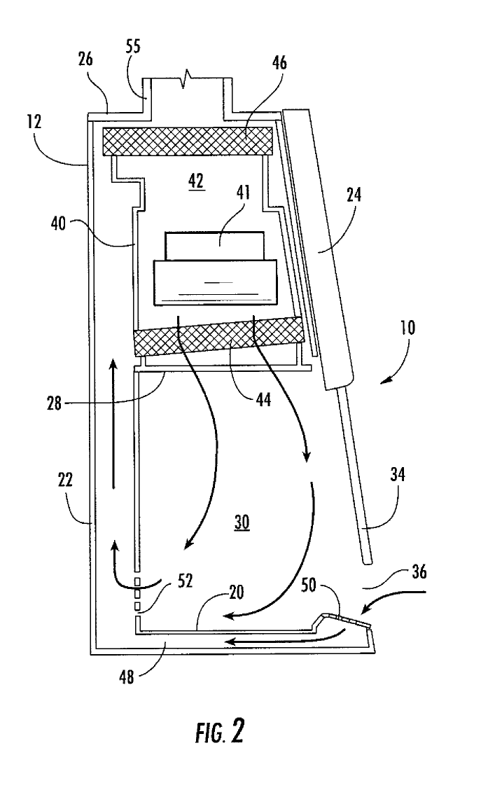

The intake side of the fan 38 draws air from within the work chamber 30 and also from the ambient air surrounding the safety cabinet 10 through hollow interior channels defined within the bottom and rear walls 20, 22 of the housing 12. More specifically, as best seen in FIG. 2, each of the bottom and rear walls 20, 22 are formed by dual spaced wall panels defining a continuous interior airflow channel 48 within the bottom wall 20 and continuing upwardly within the rear wall 22 to open into the air recirculation chamber 32. A series of perforations 50 are formed along substantially the full length of the forward edge of the bottom wall 20 to open into the forwardmost end of the airflow channel 48. A similar series of perforations 52 are formed along the lowermost end of the rear wall 22 adjacent its juncture with the bottom wall 20, also opening into the airflow channel 48 thereat.

The housing 12 of the safety cabinet will thus be understood to provide a controlled air recirculation system which operates as follows. The fan 38 continuously creates a negative pressure condition within its end of the air recirculation chamber 32 which acts through the airflow channel 48 to draw air from within the work chamber 30 through the perforations 52 and into the airflow channel 48. To a somewhat lesser extent, surrounding ambient air is drawn into the airflow channel 48 through the perforations 50. The fan 38 pressurizes the in-drawn air and discharges it under positive pressure into the filtration chamber 42 from which a portion of the air passes downwardly through the filter 44 into the work chamber and a portion of the air passes upwardly through the filter 46 into an exhaust duct 55. The filter 44 is of a substantially larger size than the filter 46 such that the majority of the airflow, preferably approximately 70%, returns into the work chamber 30 through the filter 44, with only a smaller proportion, preferably approximately 30%, of the airflow being exhausted. Within the work chamber 30, the air passing downwardly through the filter 44 moves predominantly vertically downwardly in a laminar manner which, together with the constraint of the sash 34, the constraint of incoming ambient air into the perforations 50, and the negative pressure exerted from the fan through the rearward perforations 52, substantially prevents the escape of any of the airflow outwardly through the access opening 36. Thus, users may perform laboratory procedures within the work chamber 30 utilizing hazardous substances, e.g., microorganisms, toxic chemicals, etc., without risking escape of such substances into the ambient area outside the cabinet. Moreover, as such procedures are ongoing, the continuous recirculation of the air internally within the housing 12 progressively filters airborne contaminants so as to maintain sufficient cleanliness within the internal air to prevent contamination of the procedure.

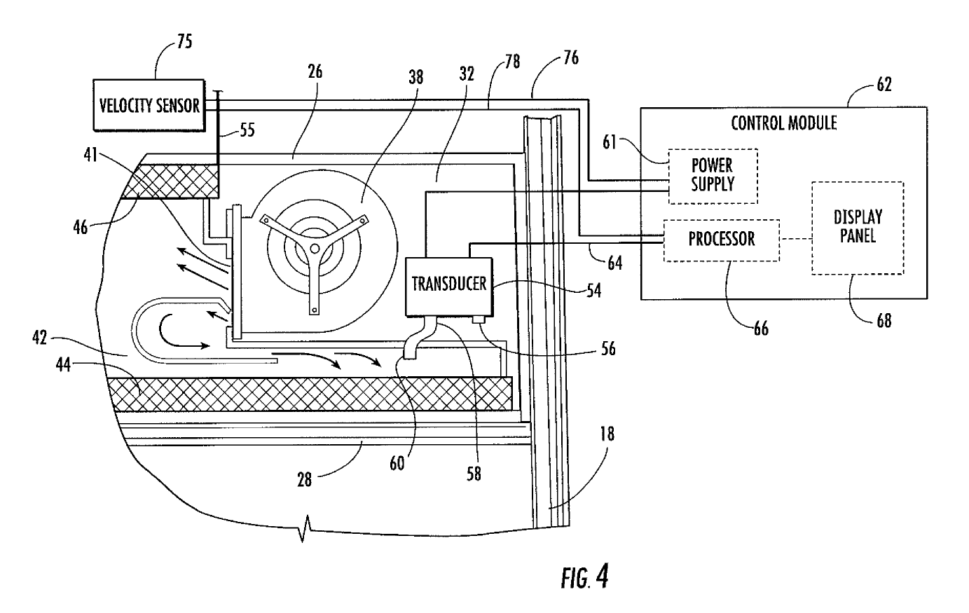

As will be understood, the filters 44, 46 will progressively become loaded with filtered contaminants over time as the cabinet is operated and, as described above, it is important to monitor the degree of filter loading so that the filters may be replaced on a periodic basis. For this purpose, a pressure transducer 54 is positioned within the air recirculation chamber 32 on the intake side of the fan 38 as depicted in FIG. 4. The pressure transducer 54 is supplied with operating electrical power from a power supply 61 within a control module 62, each shown only schematically. The transducer 54 has a first input sensor 56 which is thereby exposed to and senses the prevailing negative pressure within the recirculation chamber 32. The transducer 54 also has a second input sensor 58 which is connected via a tube 60 through a wall of the sub-housing 40 to be similarly exposed to and to sense the prevailing positive pressure within the filtration chamber 42. An output connection 64 extends from the transducer 54 back to the control module 62. The transducer 54 is operative to transmit via the output 64 a variable output voltage proportionate to and thereby representative of the differential in pressure between the negative and positive prevailing pressures sensed by the input sensors 56, 58.

As will be understood, as the filters 44, 46 become progressively loaded with contaminants, the filters impose a greater resistance to airflow through the filters and, in turn, prevailing positive air pressure within the filtration chamber 42 will increase in proportion to the degree of filter loading. On the other hand, the prevailing negative pressure within the air recirculation chamber 32 is essentially unaffected by the loading of the filters. Thus, the overall pressure differential detected by the transducer 54 is proportionally representative of the degree to which the filters are loaded. In turn, monitoring of the progressively increasing pressure differential from the time new clean filters 44, 46 are installed is indicative of the progressive loading of the filters. Accordingly, the control module 62 is equipped with a processor, indicated only schematically at 66, which has a memory and stores operating program logic for computing a quantitative value representative of the contamination loading of the filters 44, 46 as a function of changes sensed in the pressure differential over a time period of use of the filters 44, 46.

For example, the logic stored in the processor 66 may be programmed to calculate a percentage of the remaining filter capacity of the filter based upon changes sensed in the pressure differential over the use of the filters 44, 46. Such calculation may be accomplished in various ways according to various possible algorithms or mathematical computations. In a simplistic algorithm, a first lower pressure differential value may be predetermined, e.g. by actual empirical measurements or by mathematical extrapolation or calculation, to represent a value of 100% filter capacity corresponding to new clean filters 44, 46 when first installed, a second higher pressure differential value may be similarly predetermined (by measurement or other means) to represent a value of 0% filter capacity corresponding to a maximum acceptable level of loading of the filters 44, 46 at which replacement of the filters is required after a period of use, and the filters may be assumed to become loaded with contaminants during operation at a linear rate for purposes of computing a value signifying the remaining capacity of the filters 44, 46 as a percentage of the total filter capacity. Thus, a measured pressure differential at the median value between the first and second pressure differential values is calculated to signify that the filters are 50% loaded and have a 50% capacity remaining. Of course, persons skilled in the art will readily recognize and understand that this simplistic form of algorithm for determining remaining filter capacity is merely one representative illustration. The present invention is not limited to such algorithm.

As the filters 44, 46 become progressively loaded with contaminants, the velocity of air circulating within the work chamber 30 may be affected, particularly as the filters approach their full capacity to hold particulate contaminants. More fundamentally, it is critical to the operational integrity of the biological safety cabinet in preventing the escape of contaminated air into the ambient area surrounding the cabinet and to prevent internal contamination of the procedure being carried out in the work chamber 30 that the velocity of the circulating air be maintained above a minimum threshold and also not exceed a maximum value. Thus, it is also important to monitor the air flow velocity within the work chamber on an ongoing basis.

The most critical air flow parameter in this regard is the so-called face velocity of the outside air flow entering the biological safety cabinet. For this purpose, a sensor, which may be any suitable form of device capable of accurately measuring the linear speed of the laminar air flow and which is therefore only representatively depicted schematically at 75 in FIG. 4, is positioned at any appropriate location at the downstream side of the exhaust air filter 46 suitable for measuring the velocity of the air being exhausted from the cabinet, from which the so-called face velocity of the air flow entering the cabinet may be calculated since the volumes of incoming and exhausted air are equal. The sensor 75 is supplied with operating electrical power via an input lead 76 from the power supply 61 and is connected via an output lead 78 with the processor 66 for transmitting a variable output signal thereto representative of the actual prevailing face velocity of the air flow within the work chamber 30 at the sensor 75.

In order for the measured air flow face velocity to have context and to enable personnel to evaluate the acceptability or unacceptability of the prevailing measured value, the memory of the processor 66 stores a range of acceptable face velocity values. Such range may be determined in any of various ways according to differing criteria, e.g., based on experience in operation of biological safety cabinets, or empirical measurements and experimentation. Also, The National Sanitation Foundation (NSF) International has established guidelines for acceptable average face velocities in Class II biological safety cabinets. By way of example only, in the operation of the biological safety cabinet 10, an acceptable face velocity range has been set between a minimum face velocity of 80 feet per minute and a maximum face velocity of 150 feet per minute, with the preferred range being maintained between 100 and 130 feet per minute.

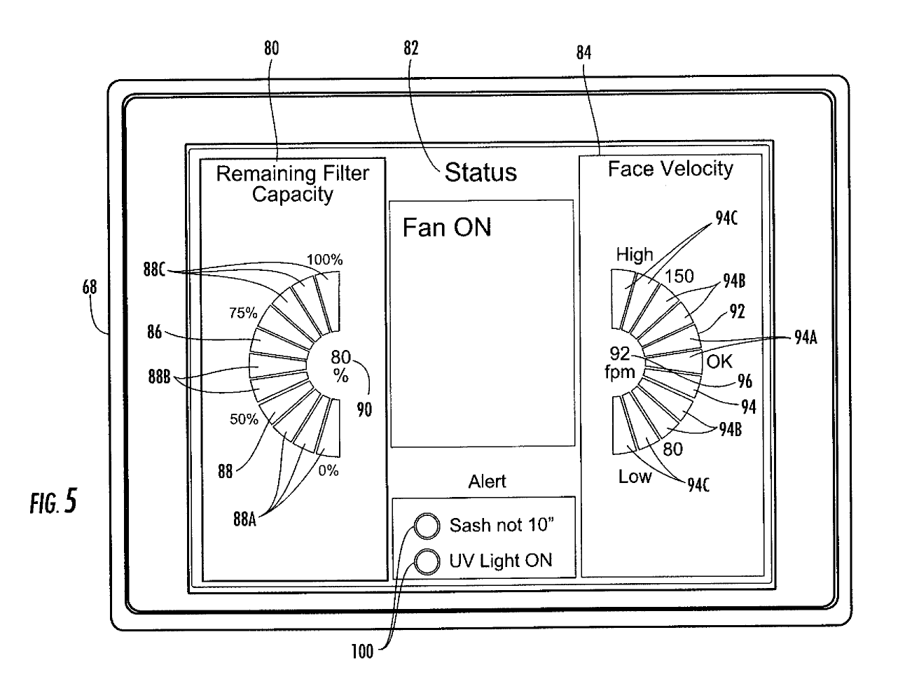

The processor 66 is connected to a display panel, indicated only schematically at 68 in FIG. 4, which is operative to display a graphical representation of the quantitative value of the remaining filter capacity and the face velocity of air flow prevailing within the biological safety cabinet 10, enabling the user to constantly monitor the progressive loading of the filters and fluctuations in face velocity as operation of the cabinet is ongoing. The display panel 68 is positioned in a conspicuous and convenient location at the front side of the cabinet 10, e.g., on the front wall 24 as indicated at 68 in FIG. 1. One possible embodiment of the graphical display of the panel is depicted in greater detail in FIG. 5. Various programmable display units are currently available in the electronics market, and it is therefore contemplated that a number of available display devices could be utilized as the display panel 68. For example, one currently available device which has been adapted for use as the panel 68 is the Coldfire® microprocessor Model No. MCF5227x, manufactured and sold by Freescale Semiconductor, Inc., of Austin, Tex.

As seen in FIG. 5, the display panel 68 has three graphical sections, arranged side-by-side, within an overall rectangular flat panel display, which include a “Remaining Filter Capacity” display section 80, a “Status” display section 82, and a “Face Velocity” display section 84. The “Remaining Filter Capacity” display section 80 includes a pictorial graphic 86 formed by a series of adjacent abutting arcuate segments 88 each in the shape of an equilateral circular sector of a semicircular annulus, and with a numerical graphic 90 located in the center area of the annulus. The “Face Velocity” display section 84 similarly includes a pictorial graphic 92 formed by a series of adjacent abutting arcuate segments 94 each in the shape of an equilateral circular sector of a semicircular annulus, and with a numerical graphic 96 located in the center area of the annulus, all in mirror image relation to the “Remaining Filter Capacity” display section 80.

The segments 88, 94 of the “Remaining Filter Capacity” display section 80 and the “Face Velocity” display section 84 are adapted to be selectively illuminated in differing colors for signifying whether the remaining capacity of the filters 44, 46 and the prevailing face velocity within the work chamber 30 of the cabinet 10 are within or outside acceptable values. For example, the color green may be utilized to illuminate segments to indicate an acceptable value, the color yellow may be utilized to illuminate segments to indicate a marginal value, and the color red may be utilized to illuminate segments to indicate a cautionary or an unacceptable value. Thus, the “Remaining Filter Capacity” display section 80 may have a sufficient number of segments 88 to represent a number of percentage increments in the total range of 0% to 100% filter capacity, with associated numerical gradations labeling at least some of the segments 88, and with the segments 88A representing the range of 50% to 0% remaining filter capacity illuminated in red, the segments 88B representing the range of 75% to 50% remaining capacity illuminated in yellow, and the segments 88C representing the range of 100% to 75% remaining capacity illuminated in green.

Similarly, the “Face Velocity” display section 84 may have a like number of segments 94 to represent increments in a total range of possible face velocities, including a central group of segments 94A which are illuminated in green to signify a mid-range of acceptable velocities, adjacent groups of segments 94B adjacent each side of the central group of segments 94A which are illuminated in yellow to signify upper and lower marginal ranges of velocities above and below the acceptable mid-range, and outer groups of segments 94C outwardly adjacent each side of the marginal group of segments 94B which are illuminated in red to signify unacceptably high and unacceptably low ranges of velocities above and below the upper and lower marginal ranges. Associated numerical gradations label at least some of the segments 94.

The “Status” display section 82 may include any of various other informational graphics, legends or alerts, as may be desirable for personnel to monitor the ongoing operation of the cabinet. For example, the “Status” display section 82 may include a video screen 98 which can display text, images, and/or alpha-numeric messages (e.g., “Fan ON”) or play video images. The display panel may also have “touch screen” inputs for enabling users to access from the memory of the processor 66 text, graphical or video content stored in the memory, e.g., an operating or service manual for the cabinet, an instructional or safety video, etc. The “Status” display section 82 may also include dedicated signal alert indicators, such as LED or similar lights 100 adjacent a dedicated informational tag, such as “Sash not 10 inches” and/or “UV Light ON.”

The operating logic stored in the processor 66 is programmed to operate the “Remaining Filter Capacity” display section 80 and the “Face Velocity” display section 84 based on the respective inputs from the transducer 54 and the velocity sensor 75, and to operate the “Status” display section 82 according to the intended functionality of the display section 82 and, as necessary or appropriate, based on any other needed sensor inputs. Specifically, the program logic of the processor 66 is operative to calculate the remaining filter capacity of the filters 44, 46 as a percentage of the total filter capacity according to the aforementioned algorithm and, in turn, to selectively illuminate, none, some or all of the segments 88 of the “Remaining Filter Capacity” display section 80, and/or to leave unilluminated or to darken other of the segments 88, as appropriate to signify graphically the percentage of the remaining filter capacity of the filters 44, 46 and thusly, by the colors of the segments alone, to signify whether the remaining capacity is within the acceptable, marginal or cautionary/unacceptable range. At the same time, the program logic of the processor 66 is operative to cause the numerical graphic 90 to display the precise numeral corresponding to the calculated percentage of the remaining filter capacity of the filters.

At the same time, and in similar manner, the program logic of the processor 66 is operative to calculate the prevailing value of the face velocity of air flow within the biological safety cabinet as sensed by the sensor 75, and to compare the calculated velocity value against the ranges of values stored in the memory of the processor 66, to ascertain whether the prevailing face velocity is within the acceptable, marginal or unacceptable range. In turn, the processor 66 is operative to then selectively illuminate, none, some or all of the segments 94 of the “Face Velocity” display section 84, and/or to leave unilluminated or to darken other of the segments 94, as appropriate to signify graphically the prevailing face velocity of the air flow within the work chamber 30 and thusly, by the colors of the segments alone, to signify whether the velocity is within the acceptable, marginal or unacceptable range. The program logic of the processor 66 is also operative to cause the numerical graphic 96 to display the precise numeral corresponding to the prevailing air flow velocity as sensed in feet per minute.

The advantages of the graphical display system of the present invention will this be apparent. The graphical layout and format of the system, and particularly, the use of color and the motion generated by the changing illumination of the pictorial graphics of the display system, provide a user friendly, intuitive and readily understood presentation of information to users, without requiring a high level of special knowledge as to the operational structure and functionality of the biological safety cabinet. The intuitive nature of the display graphics allows users to quickly review the status of the operational parameters being monitored, with minimal diversion of attention away from the procedure that is underway, and also to quickly react to undesirable changes in status when necessary. The ability of the system to store and call up text, video and other content promotes a higher level of safety in the use of the cabinet, and overcomes the potential that relevant manuals and like resources are misplaced, lost or otherwise not readily accessible when needed.

It will therefore be readily understood by those persons skilled in the art that the present invention is susceptible of a broad utility and application. Many embodiments and adaptations of the present invention other than those herein described, as well as many variations, modifications and equivalent arrangements will be apparent from or reasonably suggested by the present invention and the foregoing description thereof, without departing from the substance or scope of the present invention. Accordingly, while the present invention has been described herein in detail in relation to its preferred embodiment, it is to be understood that this disclosure is only illustrative and exemplary of the present invention and is made merely for purposes of providing a full and enabling disclosure of the invention. The foregoing disclosure is not intended or to be construed to limit the present invention or otherwise to exclude any such other embodiments, adaptations, variations, modifications and equivalent arrangements, the present invention being limited only by the claims appended hereto and the equivalents thereof.

What is claimed is:

1. A system for displaying information related to an operational parameter of a biological safety cabinet that may change during ongoing operation thereof, comprising:
a sensor for detecting a prevailing value of the operational parameter at least periodically during operation,
a display comprising a pictorial graphic having a series of adjacent arcuate segments graphically representing a range of possible values for the operational parameter between a minimum value represented by a first segment, a maximum value represented by a last segment, and incremental intermediate values represented by a plurality of segments intervening between the first and last segments, and
a processor associated with the sensor and with the display for comparing the prevailing value of the operational parameter to the range of possible values and selectively actuate illumination of all, none or another number of the segments to visually signify the prevailing value in relation to the range of values.

2. The system for displaying information related to an operational parameter of a biological safety cabinet according to claim 1, wherein the display further comprises a numerical graphic and the processor is further operative to cause the numerical graphic to display a numeral corresponding to the prevailing value of the operational parameter.

3. The system for displaying information related to an operational parameter of a biological safety cabinet according to claim 1, wherein the segments illuminate in different colors.

4. The system for displaying information related to an operational parameter of a biological safety cabinet according to claim 3, wherein at least the first segment illuminates in a first color, at least the last segment illuminates in a second color, and at least one of the intermediate segments illuminates in a third color.

5. The system for displaying information related to an operational parameter of a biological safety cabinet according to claim 1, wherein the operational parameter is a degree of contamination loading of an air filter in the biological safety cabinet.

6. The system for displaying information related to an operational parameter of a biological safety cabinet according to claim 5, wherein the degree of contamination loading is determined as a percentage of the remaining filter capacity of the filter.

7. The system for displaying information related to an operational parameter of a biological safety cabinet according to claim 1, wherein the operational parameter is a velocity of air flow circulating within the biological safety cabinet.

8. The system for displaying information related to an operational parameter of a biological safety cabinet according to claim 1, wherein the display further comprises an audio-visual screen for displaying video content stored in a memory of the processor.

9. The system for displaying information related to an operational parameter of a biological safety cabinet according to claim 1, wherein the display further comprises selectively actuable alert signals.

10. A system for displaying information related to multiple operational parameters of a biological safety cabinet that may change during ongoing operation thereof, comprising
a first sensor for detecting at least periodically during operation a prevailing value of a degree of contamination loading of an air filter in the biological safety cabinet,
a first display comprising a first pictorial graphic having a first series of adjacent arcuate segments graphically representing a range of possible values for the contamination loading of the air filter between a minimum value represented by a first segment, a maximum value represented by a last segment, and incremental intermediate values represented by a plurality of intermediate segments between the first and last segments, and further comprising a first numerical graphic associated with the series of arcuate segments,
a second sensor for detecting at least periodically during operation a prevailing value of a velocity of air flow circulating within the biological safety cabinet,
a second display comprising a second pictorial graphic having a second series of adjacent arcuate segments graphically representing a range of possible values for the air flow velocity between a minimum value represented by a first segment, a maximum value represented by a last segment, and incremental intermediate values represented by a plurality of intermediate segments between the first and last segments, and further comprising a second numerical graphic associated with the series of arcuate segments, and
a processor associated with each of the first and second sensors and with each of the first and second displays,
the processor being operative for calculating a percentage of the remaining filter capacity of the filter based upon the prevailing value of the degree of contamination loading of the air filter and selectively illuminating all, none or another number of the segments of the first pictorial graphic to visually signify the remaining filter capacity of the filter and for causing the first numerical graphic to display a numeral corresponding to the percentage of the remaining filter capacity of the filter, and
the processor being further operative for calculating the prevailing value of the air flow velocity circulating within the biological safety cabinet and selectively illuminating all, none or another number of the segments of the second pictorial graphic to visually signify the prevailing value of the air flow velocity and for causing the second numerical graphic to display a numeral corresponding to the prevailing value of the air flow velocity.
